(19) United States
(12) Patent Application Publication
(10) Pub. No.: US 2026/0154864 A1
(43) Pub. Date: Jun. 4, 2026

(54) DYNAMIC BACKGROUND PROTECTION ON EXTENDED REALITY DEVICE

(71) Applicant: GOOGLE LLC, Mountain View, CA (US)

(72) Inventor: Chang Gao, New York, NY (US)

(21) Appl. No.: 19/406,281

(22) Filed: Dec. 2, 2025

Related U.S. Application Data
(60) Provisional application No. 63/727,319, filed on Dec. 3, 2024.

(51) Int. Cl. G06T 11/00; G06T 7/90

(52) U.S. Cl. CPC G06T 11/10; G06T 7/90; G06T 2207/10024

(57) ABSTRACT

According to at least one implementation, a method includes identifying a request to display a virtual object on an extended reality device and, in response to the request, determining at least one attribute associated with a physical environment behind a location for display of the virtual object in the extended reality device. The method further includes determining a background for the virtual object based on the at least one attribute and displaying the virtual object on a display with the background.

### CROSS-REFERENCE TO RELATED APPLICATION

This application claims priority to U.S. Provisional Application No. 63/727,319, filed on Dec. 3, 2024, entitled “DYNAMIC BACKGROUND PROTECTION ON EXTENDED REALITY DEVICE”, the disclosure of which is incorporated by reference herein in its entirety.

### BACKGROUND

Wearable devices, such as extended reality (XR) devices, encompass a range of technologies designed to be worn by a user, including head-mounted displays, headsets, or glasses, that create immersive experiences by blending the physical and virtual worlds. This category includes Virtual Reality (VR) devices that fully immerse users in a computer-generated environment, as well as Augmented Reality (AR) and Mixed Reality (MR) devices that overlay digital information onto the user's view of the real world. Content is displayed on these devices primarily through either optical see-through or video see-through methods. In optical see-through systems, typically found in AR glasses, the device features transparent lenses that allow a user to view the physical world directly, with digital elements projected onto the lenses via components like projectors or waveguides. In contrast, video see-through systems, common in many VR and MR headsets, use external cameras to capture a live video feed of the real-world environment, which is then displayed on internal screens where it is combined with virtual elements to create a seamless, integrated view for the user.

### SUMMARY

This disclosure relates to systems and methods for a wearable device that dynamically generates a background for a virtual object, enabling the virtual object to remain visible against the physical environment. In some examples, a method includes, in response to receiving a request to display a virtual object, determining at least one attribute, such as color or brightness, of the physical world visible behind the display location for the object. Based on this environmental attribute, a background is determined and displayed with the virtual object. The system is adaptive and can update this background dynamically if the virtual object is moved to a new location with different environmental attributes, or if the physical environment itself changes, for instance, due to a change in lighting. In some examples, the background can manifest as a border around the virtual object and works by modifying the passthrough view of the physical world. The process for determining the background can also be based on attributes of the virtual object itself, like color, to ensure optimal contrast. Additionally, in some examples, the user can provide direct input to change the background from one state to another, allowing for manual control over the visual experience.

In some aspects, the techniques described herein relate to a method including: in response to a request to display a virtual object on an extended reality device, determining at least one attribute associated with a physical environment behind a location for display of the virtual object in the extended reality device; determining a background for the virtual object based on the at least one attribute; and displaying the virtual object on a display with the background.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the at least one processor to perform a method, the method including: in response to a request to display a virtual object on an extended reality device, determining at least one attribute associated with a physical environment behind a location for display of the virtual object in the extended reality device; determining a background for the virtual object based on the at least one attribute; and displaying the virtual object on a display with the background.

In some aspects, the techniques described herein relate to a computer-readable storage medium having program instructions stored thereon that, when executed by at least one processor, direct the at least one processor to perform a method, the method including: in response to a request to display a virtual object on an extended reality device, determining at least one attribute associated with a physical environment behind a location for display of the virtual object in the extended reality device; determining a background for the virtual object based on the at least one attribute; and displaying the virtual object on a display with the background.

The accompanying drawings and the description below outline the details of one or more implementations. Other features will be apparent from the description, drawings, and claims.

### BRIEF DESCRIPTION OF THE DRAWINGS

FIG. 1A illustrates a computing environment to provide dynamic background protection on an XR device according to an implementation.

FIG. 1B illustrates a computing environment with a dynamic background according to an implementation.

FIG. 2 illustrates a method of operating a device to provide dynamic background protection according to an implementation.

FIG. 3 illustrates a method of operating a device to provide dynamic background protection according to an implementation.

FIG. 4 illustrates an operational scenario of displaying a virtual object on a wearable device according to an implementation.

FIG. 5 illustrates an operational scenario of moving a virtual object between display locations according to an implementation.

FIG. 6 illustrates an operational scenario of selecting a background for an application according to an implementation.

FIG. 7 illustrates a computing system to manage the display of virtual objects according to an implementation.

### DETAILED DESCRIPTION

Wearable computing devices, such as Extended Reality (XR) devices, encompass a range of technologies that blend the physical and virtual worlds to create immersive user experiences. This category includes Virtual Reality (VR) devices, which fully immerse users in a computer-generated environment, and Augmented Reality (AR) or Mixed Reality (MR) devices, which overlay digital information and interactive virtual elements onto the user's view of the real world. These devices are utilized in a variety of applications, from gaming and entertainment to professional training and remote collaboration, by enhancing how users perceive and interact with their surroundings.

Content can be presented to the user through sophisticated display systems integrated into the wearable device, such as a head-mounted display. These systems often employ either optical see-through methods, where digital elements are projected onto transparent lenses, or video see-through methods, where cameras capture the real world and display it on internal screens combined with virtual graphics. Both approaches allow digital content, such as application windows or notifications, to appear overlaid upon or anchored within the user's physical environment, enabling interaction with virtual objects while maintaining awareness of the real world. Content can be presented to the user through sophisticated display systems integrated into the wearable device, such as a head-mounted display. These systems often employ either optical see-through methods, where digital elements are projected onto transparent lenses, or video see-through methods, where cameras capture the real world and display it on internal screens combined with virtual graphics. Both approaches allow digital content, such as application windows or notifications, to appear overlaid upon or anchored within the user's physical environment. As used herein, such digital content is referred to generally as a “virtual object.” This enables interaction with virtual objects while maintaining awareness of the real world.

However, overlaying virtual content onto a dynamic physical environment can present a variety of technical problems. Difficulties arise in ensuring that application content remains clearly visible and distinguishable from real-world objects, especially when the background environment changes in terms of lighting or color, causing visual interference and degrading the user experience.

In some technical solutions, an extended reality (XR) device can automatically change the background behind a virtual application to make it easier to see. The device utilizes a combination of cameras and sensors to examine the real-world environment behind the application window, checking for aspects such as color and brightness. Based on what the device identifies, the device can be configured to create a dynamic background, like a border, that helps the application stand out from the physical surroundings. This background can be updated in real-time if the user moves the application or if the lighting in the room changes. As used herein, the term background can refer to a dynamic visual element, defined by attributes such as color, brightness, or opacity, that is generated and displayed in conjunction with a virtual object. Its primary function is to visually differentiate the virtual object from the user's passthrough view of the physical environment, ensuring clarity.

In some examples, the device also allows users to manually control the level of immersion in their experience. Using an on-screen slider or button, the user can transition from augmented reality, where virtual objects are overlaid on the real world, to a complete virtual reality environment. As the user adjusts this setting, the backgrounds for applications can change to match the desired level of immersion, either allowing the user to see their physical space or completely blocking it out for greater focus.

In some implementations, the wearable device (i.e., XR device) can include various sensors, including cameras, to identify attributes of the physical environment. The sensors for understanding the environment can consist of one or more outward-facing cameras, light sensors, and/or depth sensors. The cameras can capture the real-world view for video passthrough, while the light sensors gather specific data on the ambient brightness and color of the user's surroundings. Additionally, in some examples, the system can include depth sensors, which map the room's surfaces and objects. This system allows the device to determine the visual characteristics of the physical space directly behind a virtual application window. In the context of this disclosure, the phrase “behind a location for display” refers to the portion of the physical environment that is at least partially occluded by the virtual object from the user's line of sight. As a technical effect, the understanding of the physical environment enables the device to identify potential visual conflicts, such as a dark application appearing against a dark wall.

In some examples, the device complements environmental sensing by using sensors to monitor the user's movements and interactions. Motion sensors, such as an Inertial Measurement Unit (IMU), which include accelerometers and gyroscopes, can determine the user's head position and orientation. Inward-facing infrared sensors and/or cameras can perform eye-tracking to determine the user's gaze, while other cameras can be used for hand and gesture monitoring. The user-focused data can be operations because the physical environment behind an application (or virtually displayed object, referred to as a virtual object) changes whenever the user moves their head or repositions the application window with a gesture. By monitoring the user's movements and gaze location, the device can determine when and how to update the application's background to maintain optimal visibility against the new backdrop.

For example, when a user launches an application, the wearable XR device can perform a series of steps to ensure the application is clearly visible against the user's physical environment. In response to the launch request, the device first uses its outward-facing cameras and light sensors to determine the visual attributes, such as color, brightness, and/or pattern, of the specific area in the physical world that will appear behind the application window. The location of the window itself can be a default setting for the app, a user preference, or based on where the user is currently looking.

After analyzing the physical backdrop or the physical environment, the device determines an appropriate format for a dynamic background to be displayed with the application. This background is designed to prevent visual conflicts and improve legibility. For example, suppose a user launches an application with a dark interface in a dimly lit room. In that case, the device will automatically generate a contrasting background, like a light-colored border or a semi-transparent overlay, to distinguish the application's content from the dark wall behind it. Finally, the device displays the application and its newly generated, context-aware background, providing a clear and comfortable viewing experience from the moment the application is visible.

Algorithmically, the selection of this background format is predicated on a contrast-maximization principle. The system first computes a similarity score between the measured visual attributes (e.g., luminance and chrominance vectors) of the virtual object and the corresponding physical background. If this score exceeds a predefined low-contrast threshold, the background generation module is activated. This module then determines background parameters that are functionally oppositional to the detected attributes. For a low-brightness environment and object, the system can select a high-brightness background color, which can be chosen from a palette of complementary or inverted colors relative to the dominant hue of the background. The opacity level can be determined as a function of user-configurable immersion settings or application-defined modes, allowing the system to balance legibility with the user's desired level of environmental awareness.

Further, after the application is launched, the XR device can be configured to monitor the changing physical environment (i.e., attributes) behind the window to update its background protection dynamically. For instance, suppose a user is viewing a document with a default dark theme, which is initially placed in front of a brightly lit, white wall. The device's sensors detect this high-contrast situation and may apply a minimal, subtle background, like a thin, dark border, to define the application's edges against the bright surface.

As the user physically walks or uses a hand gesture to drag the application window across the room, the device's cameras and sensors track its new position in real-time. If the user moves the window so it is now in front of a dark wooden bookshelf in a poorly lit corner, the system detects a significant change in the background's color and brightness. This change triggers an update. In response, the device instantly replaces the original subtle border with a more prominent, light-colored, and semi-transparent background. This new background creates a necessary visual separation, ensuring the dark-themed application content remains clear and legible against the dark physical backdrop.

In some implementations, the device can be configured to determine where to open the application based on a variety of settings. The location can be a default position pre-set for that specific application, a location explicitly defined as a preference by the user, or an area where the user is currently looking (i.e., gaze focus), placing the application directly in their line of sight. Users can also set different initial locations for various applications, such as anchoring one application to a wall and another to the floor, or a first application to the left side of the user's perspective and a second application to the right side of the user's perspective. In some implementations, the application can be opened in an area of high contrast, permitting the application to be distinguished from the physical environment (e.g., light application on dark background). In some examples, when an application is launched, the device's sensors can analyze the physical background and determine whether any background is required for the application. Suppose sufficient natural contrast already exists in the opening location, such as placing a light-colored application against a dark wall. In that case, the system may determine that no significant background protection is needed. In this scenario, the device can be configured to display the application with a minimal or no border, since the content is already legible against the environment.

In some implementations, the user can provide input via an interface that adjusts the visibility of the physical environment to the user in the XR device. In some examples, the user can use a slider to adjust the visibility. This user interface element allows the user to adjust the blend between the physical and virtual worlds manually. By moving the slider, the user can seamlessly shift from a full passthrough mode, where the physical environment is evident, to a mixed reality mode with a dimmed or blurred background, and finally to a fully immersive virtual reality mode where the physical space is completely obscured, allowing the user to focus entirely on the virtual content.

In addition to the slider, visibility can be updated based on application-specific settings or user-defined physical zones. For example, a user can set a preference for an application to automatically enter a “theater mode,” which dims the entire physical environment to enhance the viewing experience. The user can also define specific areas in a room that trigger an automatic transition from augmented to virtual reality when they move into that space, providing a context-aware method for controlling how much of the real world they see.

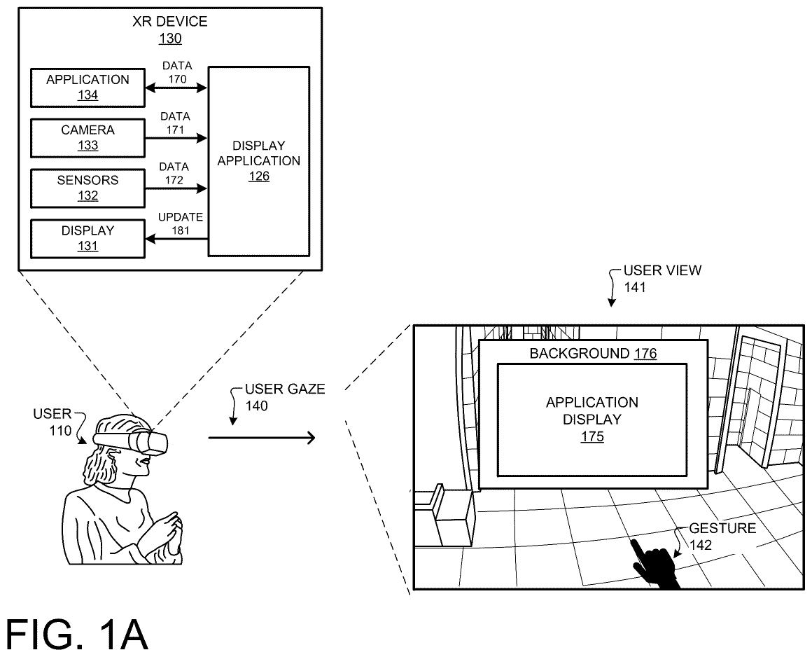

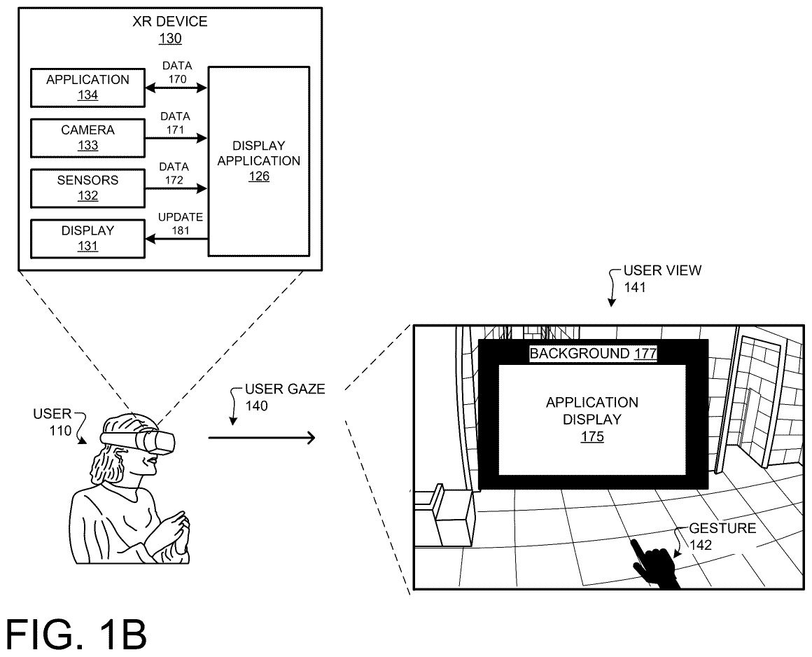

FIG. 1A illustrates a computing environment to provide dynamic background protection on an XR device according to an implementation. FIG. 1A demonstrates the display of an application with a background that supports contrast for distinguishing the application against the physical environment. FIG. 1A includes user 110, XR device 130, user gaze 140, and user view 141. XR device 130 includes display 131, sensors 132, camera 133, application 134, and display application 126. XR device 130 further includes data 170, data 171, data 172, and update 181. User view 141 is representative of the view for user 110 and includes gesture 142, application display 175, and background 176. Although demonstrated as a border or behind application display 175, background 176 can be incorporated at least partially into the application itself. For example, in a video call application, the background could be used as the background for other personnel in the call.

In the computing environment of FIG. 1A, XR device 130 includes display 131, which is a screen or projection surface that presents immersive visual content to user 110, merging virtual elements with the real world or creating a completely virtual environment. In some examples, the display works by using a pair of small, high-resolution displays, one for each eye, placed very close to the face. Specialized lenses between the eyes and the displays magnify and focus the images, making them appear as a large, immersive picture that fills your field of view. For augmented reality, this system either projects digital content onto transparent lenses (optical see-through) or blends it with a live camera feed of the real world (video see-through).

XR device 130 further includes sensors 132, including accelerometers, gyroscopes, magnetometers, depth, infrared, and proximity sensors. The sensors can be used to monitor the user's physical movement, identify depth information for other objects, identify eye movement for the user, or provide some other operation. XR device 130 also includes camera 133 that can capture the real or physical environment to overlay virtual objects (e.g., application interfaces or windows) seamlessly and track the movements of user 110 and surroundings to enable accurate interaction within the augmented or virtual space. In some examples, camera 133 can be positioned as an outward view to capture the physical world associated with the user's gaze. Display 131 can be used to display information using optical see-through or video see-through methods. Optical see-through devices, like AR glasses, have transparent lenses that let users view the real world directly, with digital elements overlaid via projectors or waveguides. In contrast, video see-through devices, including VR headsets, can use external cameras to capture real-world video and display it on internal screens, combining it with virtual elements to create a seamless augmented view. Both methods can enable users to interact with digital content while remaining aware of their physical environment.

As illustrated in FIG. 1A application 134 is displayed by XR device 130 as application display 175 with background 176. In some examples, display application 126 is configured to, in response to a request to open or execute application 134 (e.g., to execute the application), determine at least one attribute associated with a physical environment viewable behind a location for the application on display 131. A request can refer to an input signal generated by a user interaction, such as a gesture or voice command, which instructs the system to perform an action related to a virtual object, such as displaying it. At least one attribute can include the color or brightness of the background that the application will open over, or other information about the physical environment. The location can be determined based on a preference from the user, a default for the application, or based on some other setting. Display application 126 can further determine a format for background 176 for the application based on the identified one or more attributes. The format can include color, opacity, brightness, size, and other visual properties. In some implementations, the format is further determined based on preferences associated with the application (e.g., more immersive or application-focused, which can make it a darker background, permitting the user to focus on the application over the physical environment). Once the format is determined, display application 126 can provide an update to display 131 with application display 175 and background 176.

Although demonstrated as a border, the background may cover additional portions of the user's field of view in some examples. For example, the background can be dimmed in a bright room for the user's entire field of view outside the application. As at least one technical effect, the user can focus on the application without distractions from the physical environment. Alternatively, in a dark room, the device may not dim the background to avoid interfering with the application's presentation. In some examples, the term background can be defined as a configurable visual layer rendered with a virtual object that can manifest as a border, a modification of the passthrough view, or a fill for the object's negative space. This layer is used to ensure the virtual object remains visually distinct from the physical world.

In some implementations, when application 134 is launched, XR device 130 uses camera 133 and sensors 132 to analyze attributes of the real-world view behind the application's intended location, such as ambient color and brightness. Based on this environmental data, display application 126 generates a background, which could be a border, a semi-transparent layer, an adjustment to the negative space in the application (e.g., behind a user in a video call), or a dimming effect on the surrounding view, formatted to ensure the application is clearly visible.

For example, when user 110 launches a virtual object, such as a video calling application window, XR device 130 first determines its placement based on system defaults or user settings. For instance, the system might anchor the application window to a physical surface like a wall. Before rendering the window, the device's sensors analyze the attributes of the wall behind it, such as its color and the room's ambient light, and then generate a contrasting background border to ensure the application is clearly visible. Here, application display 175 is placed on a wall with background 176, which can provide a contrast to the colors of the physical environment.

Turning to FIG. 1B, FIG. 1B replaces background 176 from FIG. 1A with background 177 based on the physical environment viewable on the extended reality device and behind the display of the application, satisfying at least one criterion. In some implementations, XR device 130 determines that a change (color, brightness, etc.) in the physical environment satisfies a criterion. A criterion can refer to a predefined logical condition or a quantifiable threshold that, when satisfied, triggers a system action, such as updating a background. A criterion may be satisfied, for example, when a measured attribute of the physical environment, such as brightness, changes by a set amount, or when a relationship between an environmental attribute and a virtual object attribute meets a specific condition. In response to satisfying the criterion, display application 126 can replace background 176 with background 177. For instance, the user's physical environment may transition from a bright to a dark environment. In response to the transition, the background can change from one format to another (e.g., a different color, transparency, etc.). In some implementations, the background represents a border that is displayed around the application window. The border can include a color, transparency, shape, or some other formatting element for the displayed border. In some implementations, the background can be included at least partially in the application window. The background can be included in the negative space of the application window. Negative space in an application refers to the unoccupied areas in the interface, which help separate and highlight elements, improve readability, and enhance the overall user experience by reducing visual clutter. For example, in a video call application, the background can be included behind the people in the video call. The background can consist of colors, patterns, transparency, or some other formatting to improve the visibility of the application with respect to the physical environment.

In some implementations, user view 141 includes multiple portions. The first portion is the physical environment visible to the user via passthrough (optical or video see-through). This allows the user to view the physical environment's walls, doors, screens, or other objects. The second portion is the application display 175, which is the application window overlaid on the physical environment. The application is viewable to the user rather than the physical environment behind the application. The third is the background (i.e., background 177). The background can comprise a color, an amount of transparency, or some other background that can distinguish the application from the physical environment visible to the user. For example, a light background with partial transparency can provide the technical effect that user 110 can distinguish the application window from the physical environment.

In some implementations, an outward-facing camera 133 and sensors 132 work together to monitor the user's physical surroundings by capturing images and collecting data on environmental factors like color and brightness. This information is used to analyze the scene behind any virtual content being displayed. If XR device 130 detects that the virtual content might be hard to see, for instance, a dark video playing in a dimly lit room, display application 126 and XR device 130 will automatically generate and update background 176 to background 177, such as a contrasting border or a semi-transparent layer, to make the virtual elements stand out clearly and ensure they don't blend in with the real world.

In at least one illustrative example, a user can view a virtual photo album on XR device 130. Initially, to make the bright photos stand out against the dark physical walls, the system generates a first background 176, which is a solid, dark gray, semi-transparent border around the photo album application. This creates a clear separation between the virtual content and the real world. Then, someone opens the window blinds, and the room is flooded with bright sunlight. The device's sensors (e.g., camera 133 or sensors 132) detect this sudden increase in brightness. In response, the XR device 130 determines an update to a second background 177, changing the border to a much lighter, soft white color with increased transparency. This new, brighter background ensures the virtual photo album remains clearly visible and feels integrated with the now brightly lit environment

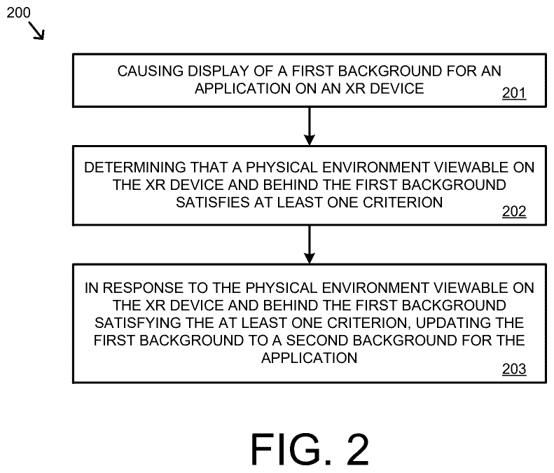

FIG. 2 illustrates method 200 of operating an XR device to provide dynamic background protection according to an implementation. The steps of method 200 are parenthetically referenced in the following paragraphs, including systems and elements of FIGS. 1A and 1B.

Method 200 includes causing (201) display of a first background for an application on an extended reality device. As depicted in FIG. 1A, XR device 130 provides a display for application 134 as application display 175 with background 176. Background 176 can be a first color, a first opacity, a first size, a first shape, or some other visible background element for application display 175. Method 200 further determines (202) that a physical environment viewable on the extended reality device and behind the first background satisfies at least one criterion. The at least one criterion can comprise a threshold change in color, a threshold change in brightness, or some other change in association with the physical environment in view behind the application. In some implementations, the at least one criterion can comprise a threshold relationship between color and brightness of the physical environment to the content of the application itself. For example, the device can determine when the background color or brightness is closely aligned to the color and brightness of the application. In these instances, the user can prefer a contrasting or differentiating background for the application to distinguish the background from the physical environment.

In response to the physical environment viewable on the extended reality device and behind the first background satisfying at least one criterion, updating (203) the first background to a second background for the application. The update from the first to the second background can include a change in color, brightness, shape, or some other change associated with the background. In at least one example, the background is used to distinguish the application from the physical environment from the user's perspective.

For example, while background 176 is provided by XR device 130 when the device is in a first condition for the physical environment (e.g., bright room), XR device 130 can determine when the lighting changes. In response to the change in lighting (e.g., room moving from bright to dark), the display application 126 and XR device 130 can identify an update to the background. The update can change background 176 in FIG. 1A to background 177 in FIG. 1B, wherein the update can include a change in color, brightness, shape, opacity, or other visual modification.

In some implementations, before displaying an application on the device's display, the device can determine at least one attribute associated with a physical environment viewable behind a location for the application on the display. The device can further determine a format for a background for the application based on at least one attribute, the format including color, brightness, shape, opacity, or other visual attributes associated with the background for the application. In some implementations, the at least one attribute can include color, brightness, or other visual characteristics associated with the physical environment. In some implementations, the device can consider the colors or brightness associated with the application to determine a distinguishing background for the application from the physical environment. Once the format is determined, the device can display the application on the display with the format for the background. For example, if the device is in a dark room and displays a dark application, a light background can be created that distinguishes the application's content from the physical environment.

The system's selection of an appropriate background is based on an algorithmic process designed to maximize contrast and ensure legibility. Upon launching an application, the device's sensors measure the visual attributes, such as luminance (brightness) and chrominance (color), of the physical environment behind the application window. Concurrently, the system analyzes the visual characteristics of the virtual object itself, including its user interface colors and content. The device then compares these two sets of attributes. If the contrast between the application and the physical backdrop falls below a predefined threshold, indicating they are too visually similar to be easily distinguished, the system triggers the generation of a dynamic background.

Once triggered, the algorithm can determine the specific properties of the background to create a clear visual separation. For color and brightness, the system can be configured to compute an opposing value. For instance, if both the application and the environment are dark, the system will select a background with high brightness, often choosing a color that is complementary or inverted relative to the dominant hue of the physical backdrop. The opacity of the background is often determined based on other factors, such as the application's purpose or user preferences. An application in “theater mode,” for example, might be assigned a highly opaque background to foster immersion, whereas a productivity application might receive a semi-transparent background to maintain the user's awareness of their physical surroundings. This multi-factor determination ensures the background is contextually appropriate.

Furthermore, the generated background is not required to be uniform in its visual properties. In some implementations, the system analyzes the physical environment on a more granular level, assessing the visual attributes of different portions of the backdrop behind the virtual object. For instance, if a single application window is positioned such that it partially overlaps a bright, sunlit area and partially a dark, shadowed wall, the system can generate a correspondingly non-uniform background. The portion of the background overlaying the bright physical area will be rendered with low brightness to create contrast, while the portion overlaying the dark wall will be rendered with high brightness. This results in a single, cohesive background that dynamically varies in color, brightness, or opacity across its surface to counteract localized visual conflicts with the underlying physical scene.

In some implementations, users can provide preferences associated with an application to define how a background visually appears. The user can indicate the color, shape, or other information related to the background or border of the application. In some examples, the user can define where an application appears in the user's field of view. In some examples, the user can indicate different background preferences for various portions of the user's physical environment. For example, the user can indicate that applications that are anchored near the floor are provided with a first background format (e.g., more transparent). In contrast, applications that are anchored higher, such as on a wall, are provided with a second background (e.g., darker or block more of the physical environment).

In some implementations, the user can indicate locations (e.g., a portion of the floor, a portion of a room, or a portal) for when to transition from augmented reality to virtual reality. For example, the user can start in a first portion of the room in augmented reality, cross over into a second portion of the room and transition into virtual reality. The portions can be defined by defining spaces within the room. The device can learn the room by using cameras and depth sensors to scan and create a digital map of the space, identifying surfaces, objects, and boundaries. The user can then provide input via gestures or controllers indicating boundaries associated with the different types of extended reality (i.e., virtual, augmented, mixed, and the like).

In some implementations, the user interface may provide a slider, a dropdown menu, or another interface that allows users to select different levels or types of extended reality. For example, the user can use a gesture with a displayed slider to transition from augmented reality to virtual reality. As the user changes the slider, the backgrounds for one or more applications can be adjusted to reflect the user's preference. For example, when going from augmented to virtual reality, the backgrounds can be adjusted so that the physical environment is no longer visible to the user following the transition. Multiple tiers can exist, from full augmented reality to virtual reality.

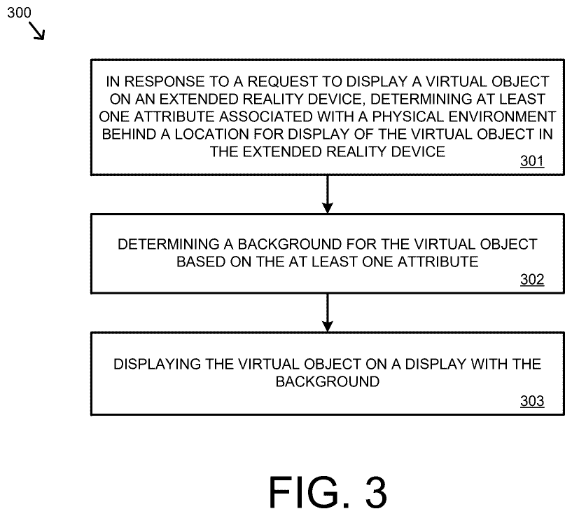

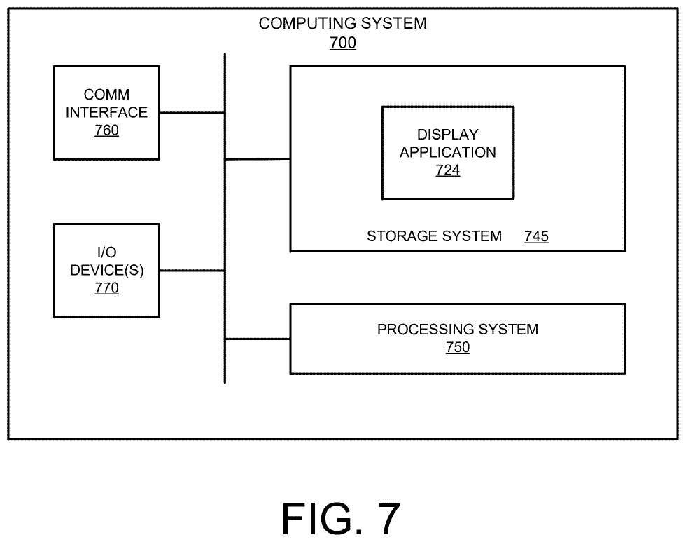

FIG. 3 illustrates method 300 of operating a wearable device to support dynamic backgrounds for virtual objects according to an implementation. The steps of method 300 can be performed by a wearable device, such as an XR device, or computing system 700 of FIG. 7.

Method 300 includes, in response to a request to display a virtual object on an extended reality device, determining at least one attribute associated with a physical environment behind a location for display of the virtual object in the extended reality device at step 301. In some implementations, a wearable device can include one or more sensors or cameras that can capture information about the physical environment. In some examples, the device can determine a location for the virtual object in the user's field of view. Using its outward-facing cameras and sensors, the device then analyzes the specific portion of the real-world physical environment that sits behind this location. This analysis involves capturing key environmental attributes, such as visual characteristics like the ambient brightness and the dominant colors of the physical background. For example, when a user initiates execution of a media player application, the wearable device first determines the default location for the new application window, such as the center of the user's field of view. The location can be determined based on preferences for the application, the gaze of the user, the current layout of other applications, or another factor. The outward-facing cameras and light sensors of the device then analyze the specific portion of the living room wall that is directly behind this location. If the sensors detect that the wall is painted a dark blue and the ambient lighting is dim, the system records these attributes (i.e., low brightness and dark blue color).

Method 300 further includes determining a background for the virtual object based on the at least one attribute at step 302 and displaying the virtual object on a display with the background at step 303. In some implementations, the device can be configured to use the at least one attribute, and in some cases the characteristics of the application itself, to determine and select a format for the background of the application. The device can be configured to generate a background that creates a clear visual distinction between the application and the physical world, for instance, by creating a light-colored background if both the application and the physical room are dark. This determined background format can be defined by various properties including its color, brightness, opacity, shape, and size, and can be rendered in different ways, such as a border around the application, a fill for the negative space within the application's user interface, or as a dimming effect applied to the user's broader view of their physical surroundings to enhance focus on the virtual content.

In some implementations, when first starting an application, the wearable device can be configured to assess and establish a necessary contrast level between the application (i.e., virtual object) and the physical background by using thresholds. Upon receiving a request to execute an application, the device determines the visual attributes, such as color and brightness, of both the physical environment behind the application's display location and the content of the application itself (e.g., the color of the interface for the application, or content displayed for the application, such as media to be played in the application). A threshold can be satisfied if the relationship between these attributes is too similar (e.g., color value and/or brightness value). For example, if a dark application is set to appear in a dark room. When this threshold for low contrast is satisfied, the device automatically determines and generates a background format (e.g., a lighter color or border) specifically to create a clear visual distinction, ensuring the application is immediately legible and distinguishable from the physical environment. In some examples, when the threshold is not satisfied, then no border may be applied or generated.

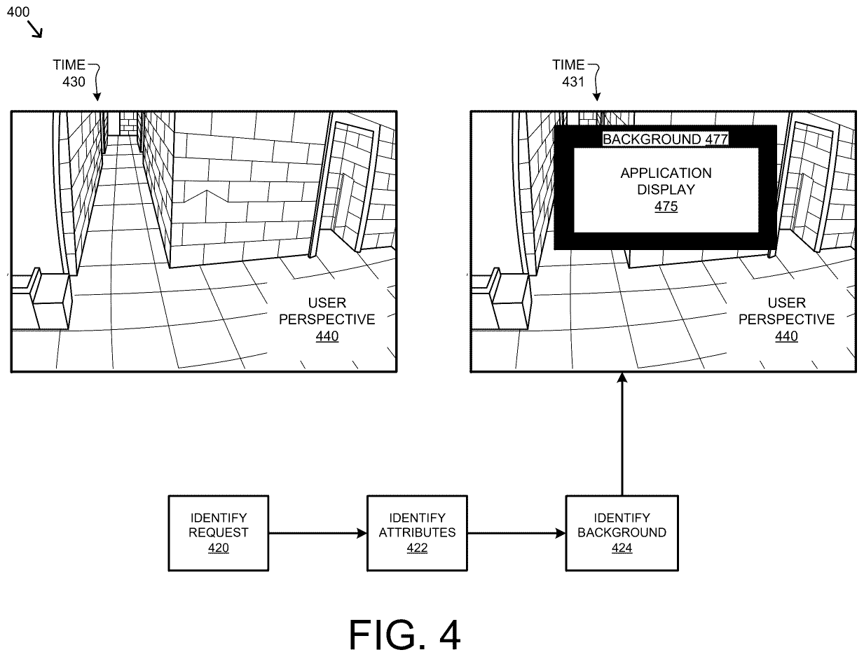

FIG. 4 illustrates an operational scenario 400 of displaying a virtual object on a wearable device according to an implementation. Operational scenario 400 includes a user perspective 440 at time 430 and time 431. Operational scenario 400 further includes step 420, step 422, and step 424 that are representative of operations that a wearable device, such as an XR device, can perform. In some implementations, the operations can be performed by computing system 700 of FIG. 7.

In operational scenario 400, user perspective 440 at time 430 depicts a room with bright lighting. While in the room, a user can generate a request to launch or execute an application (an example of a virtual object). The wearable device is configured to identify the request at step 420 and identify attributes associated with the physical environment at step 422. In some implementations, users can open an application via a voice command, such as “Open Maps,” for a hands-free launch. In some examples, users can open an application through direct hand interaction, where the user can bring up a virtual menu and select an application icon by air tapping or pinching their fingers together. In other examples, physical controllers can be used to point a virtual pointer at the desired application and launch it with a button press. More advanced interactions include gaze control, where a user can select an application simply by looking at an icon for a moment (dwell-to-select) or by combining their gaze with a gesture or controller input.

In response to the selection, the wearable device can receive and process attributes associated with the environment from image and lighting sensors. In some implementations, the system identifies attributes such as the color, brightness, contrast, and opacity of the physical space that is visible behind the location where a virtual application is displayed. This data is then used to dynamically determine and create a background for the application, ensuring that its content is clearly visible and distinguishable from the user's real-world surroundings. In some implementations, the attributes can further include information about the application itself and the display thereof. The attributes for the application can consist of the color and brightness of the content, position, scale, and dimensions within the user's view. The system can also consider user-defined preferences tied to the specific application, such as its desired level of immersion (e.g., “theater mode”), a pre-set anchor location in the physical environment (like a wall or floor), and the preferred format for its background or border. The device can determine the nature of the content, such as whether it is a 2D panel or a more complex 3D object requiring multiple planes. From the attributes of the environment and/or the application, the device can identify background 477 for application display 475.

As depicted in operational scenario 400, background 477 represents a dark background around application display 475. For example, suppose a user is in a brightly lit office and opens a web browser application that displays a predominantly white webpage. In that case, the system identifies the high brightness of both the physical environment and the application's content. To improve focus and distinguish the application from its surroundings, the device automatically dims the user's view of the physical office (or portions of the physical office). This creates a dark, semi-transparent background around the light-colored browser window, causing the application to stand out clearly and making its content easier to read without visual interference from the bright real-world objects behind the window. In some alternative examples, the system can distinguish the content by blurring the physical environment visible behind the application or by applying a clean-edged, semi-transparent layer that adapts its color to contrast with the surroundings. Furthermore, in some examples, the user can be given control over immersion levels, allowing them to use a slider to transition the entire view from a clear augmented reality passthrough to a fully opaque virtual environment, effectively eliminating background distractions.

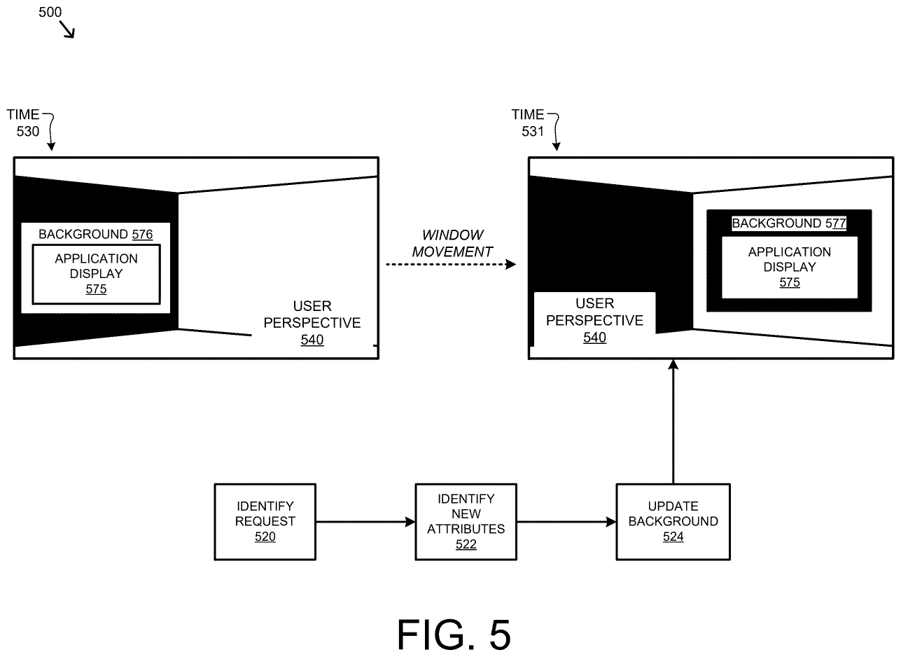

FIG. 5 illustrates an operational scenario 500 of moving a virtual object between display locations according to an implementation. Operational scenario 500 includes a user perspective 540 at time 530 and time 531. Operational scenario 500 further includes step 520, step 522, and step 524, which are representative of operations that a wearable device, such as an XR device, can perform. In some implementations, the operations can be performed by computing system 700 of FIG. 7.

In operational scenario 500, application display 575 is provided over background 576 at time 530 in user perspective 540. For example, if a user opens a photo editing application and places its window (application display 575) in their augmented reality view, anchored against a dark, navy-blue wall. The device's sensors and camera identify the low brightness and dark color of the physical surface behind the application. To ensure the application window and its controls are clearly visible, the system automatically generates a background that appears between the application and the physical wall to enhance the user's ability to distinguish between the physical space and the application display 575.

At step 520, the system identifies input for the user to move application display 575 from the first position at time 530 to the second position at time 531. In response to the request, the system can identify an update to the display of application display 575 at step 522 and update the background at step 524. As depicted in the example of operational scenario 500, a user operating the device first places a video application window against a dark-painted wall in their physical environment. The wearable device, using sensors to detect the low-light background, automatically generates a light-colored border around the application to ensure its edges are clearly visible. Subsequently, the user moves the application window from the dark wall to a position in front of a bright, sunlit window. The device detects this change in the physical environment behind the application, then updates the application's visual treatment by replacing the light border with a dark, contrasting one, thus maintaining optimal visibility and distinction between the application window and its new, lighter background 577.

Although demonstrated as providing a background at both time 530 and time 531, in some examples, a device can be configured not to provide a border if unnecessary. For example, when a device user executes an application with dark attributes, the device may not display a border in a bright physical environment. In some implementations, the device compares the application's attributes with those of the environment to determine if the criteria are met for displaying a background with the application window. If the requirements are not satisfied, then no background will be provided with the application.

In some implementations, the background may not be a single or solid color or display. Instead, the background can change based on the physical environmental characteristics on which the virtual object is overlaid. For example, a first portion of the background can be dark when positioned over a well-lit portion of the physical environment. In contrast, a second portion of the background can be a lighter or different color that is placed over the physical environment with other attributes.

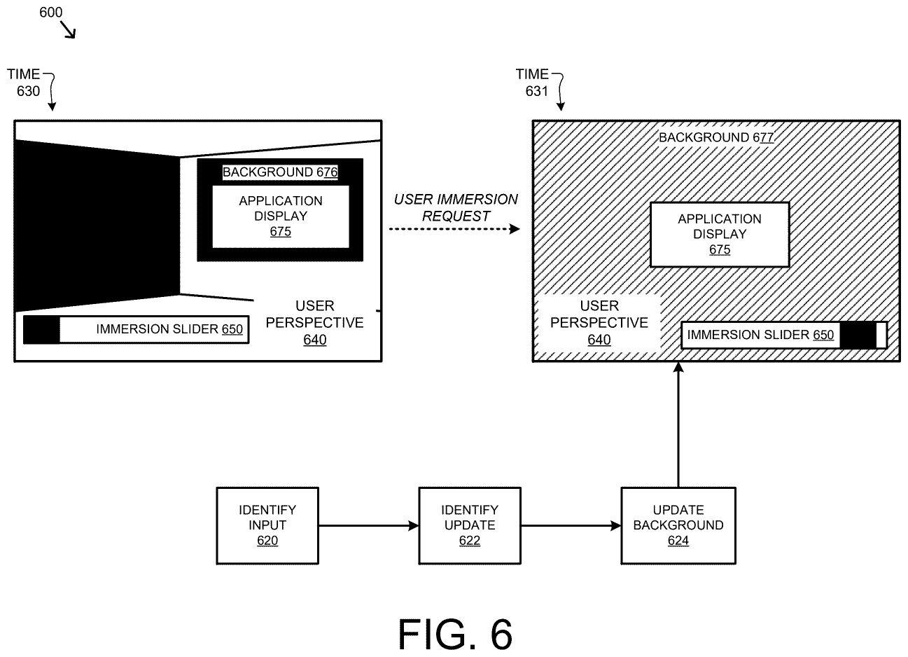

FIG. 6 illustrates an operational scenario 600 of selecting a background for an application according to an implementation. Operational scenario 600 includes user perspective 640 at time 630 and time 631. Operational scenario 600 further includes immersion slider 650, application display 675, background 676, and background 677. Operational scenario 600 also includes step 620, step 622, and step 624, which are representative of operations that a wearable device, such as an XR device, can perform. In some implementations, the operations can be performed by computing system 700 of FIG. 7.

In operational scenario 600, In operational scenario 500, application display 575 is provided over background 576 at time 530 in user perspective 540. Background 676 is provided based on the settings associated with immersion slider 650. For example, when immersion slider 650 is positioned to the left at time 630, the user can launch a video-conferencing application on a dark wall. Upon launching the application, the device can be configured to anchor the application window as application display 675 to a large, clear section of the white wall. The device's sensors can be configured to detect the high brightness and light color of the physical background. To ensure the application is clearly visible and to reduce visual conflict with the bright environment, the system can generate background layer as background 676 behind and around the video-conferencing window. This dynamic background protection makes the application's content stand out, improving readability and focus for the user. Although demonstrated as an additional background that is around and behind application display 675, the background can be placed in the negative space of the application (e.g., as a background of another user in the video conference), or can be placed in some other means that can distinguish content for the application from the physical environment.

After displaying application display 675 with background 676, the device can be configured to identify input from the user changing the amount of immersion associated with the application at step 620. For example, the user can use immersion slider 650 to transition from a first level of immersion to a second level of immersion. A user can transition between different levels of immersion, such as from a first level in AR to a second, more immersive level in virtual reality VR, through direct interaction with the user interface. The user interface may provide an interactive element like a slider, menu, or button that allows for manual adjustment of the immersion level. For instance, by making a gesture to move a displayed slider, the user can seamlessly shift the experience. As the slider is adjusted, the background representing the physical environment can be modified, becoming progressively more obscured, dimmed, or replaced entirely, thus increasing the user's focus on the virtual content and moving them from a passthrough or AR mode to a mixed or fully virtual reality. Accordingly, the device can identify an update for the display at step 622 based on the user request and update the background at step 624.

In some implementations, rather than receiving user input to transition the backgrounds associated with the application (e.g., AR to VR), the transition between immersion levels can be triggered by the user's physical movement within their environment. A user can pre-define specific regions or portals within a room that correspond to different extended reality experiences. For example, a user might be in an AR mode when in the main area of a room, but upon stepping into a designated corner or crossing a virtual boundary, the device can automatically transition to a fully immersive VR environment. The device can be configured to identify the physical space using its cameras and sensors, allowing the user to map these zones for automatic and intuitive switching between various levels of immersion based on their location.

FIG. 7 illustrates a computing system 700 to manage the display of virtual objects according to an implementation. Computing system 700 is representative of any computing system or systems with which the various operational architectures, processes, scenarios, and sequences disclosed herein can be implemented to display virtual objects with varying backgrounds. Computing system 700 may represent a wearable computing device, such as an XR device or smart glasses. Computing system 700 can include multiple computing devices in some examples (e.g., a wearable device and a companion device, such as a smartphone or tablet). Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format, including combinations thereof. Communication interface 760 may be configured to communicate with external devices, such as servers, user devices, or some other computing device.

I/O device(s) 770 may include computer peripherals that facilitate the interaction between the user and computing system 700. Examples of I/O device(s) 770 may include keyboards, mice, trackpads, monitors, displays, printers, cameras, microphones, external storage devices, and the like.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for information storage, such as computer-readable instructions, data structures, program modules, or other data. Storage system 745 may be implemented as a single storage device, but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or another form of machine-readable program instructions. The operating software of storage system 745 comprises display application 724. The operating software on storage system 745 may include an operating system, utilities, drivers, network interfaces, applications, or other types of software. When read and executed by processing system 750, the operating software on storage system 745 directs computing system 700 to operate as described in the previously described FIGS. 1-6.

In at least one implementation, display application 724 directs processing system 750 to identify a request to display a virtual object. For example, the user can provide a request to start an application on the device, where the application window is an example of a virtual object. Other virtual objects can include simple icons, 3D models, floating text, interactive menus, holographic characters, or immersive environmental elements. The location on the display can be based on preferences associated with the virtual object, the gaze of the user, or some other factor.

In response to the request, display application 724 directs processing system 750 to determine at least one attribute associated with a physical environment behind a location for display of the virtual object in the extended reality device. In some examples, cameras and light sensors work in concert to capture visual information, determining characteristics such as the color, brightness, and ambient lighting conditions of the physical surroundings. To identify the spatial layout, depth sensors and cameras can be configured to scan the area to create a digital map. This process can locate the surfaces, objects, and boundaries within the space. In some examples, a suite of other sensors, including accelerometers, gyroscopes, magnetometers, infrared, and proximity sensors, further contributes by monitoring the user's physical movement, identifying depth information for objects, and tracking the user's position and orientation relative to the captured environment.

Once the attributes are identified in association with the physical environment, display application 724 can be configured to determine a background for the virtual object based on the at least one attribute and display the virtual object on a display with the background. For instance, if a user is in a dimly lit living room with dark blue walls, the device's camera and light sensors identify the low ambient light and the specific dark blue color of the physical environment. When the user launches a video streaming application to watch a movie with many dark scenes, the system recognizes that both the application's content and the physical background are dark. To prevent the virtual movie screen from blending into the wall, the system automatically generates a soft, light-colored, semi-opaque border or glow around the application window. This dynamic background provides a clear visual distinction between the virtual content and the real-world surface behind it, ensuring the application remains clearly defined and easy to view.

Below are example clauses associated with the present disclosure. The described clauses should not be considered exhaustive.
Clause 1. A method comprising: in response to a request to display a virtual object on an extended reality device, determining at least one attribute associated with a physical environment behind a location for display of the virtual object in the extended reality device; determining a background for the virtual object based on the at least one attribute; and displaying the virtual object on a display with the background.
Clause 2. The method of clause 1, wherein the location comprises a first location, wherein the background comprises a first background, and the method further comprising: identifying a request to move the virtual object from the first location for display to a second location for display; determining at least one additional attribute associated with the physical environment behind the second location for display; determining a second background for the virtual object based on the at least one additional attribute; and displaying the virtual object on the display with the second background in place of the first background.
Clause 3. The method of clause 1, wherein the background comprises a first background, and the method further comprises: determining a change of the at least one attribute to at least one second attribute; determining a second background for the virtual object based on the change of the at least one attribute to at least one second attribute; and updating the virtual object on the display with the second background in place of the first background.
Clause 4. The method of clause 1, wherein the background modifies at least a portion of the physical environment visible as a passthrough to a user of the extended reality device.
Clause 5. The method of clause 1, wherein the background comprises a border around the virtual object.
Clause 6. The method of clause 1 further comprising: determining at least one additional attribute associated with a color for the virtual object, wherein determining the background for the virtual object based on the at least one attribute is further based on the at least one additional attribute.
Clause 7. The method of clause 1, wherein the background comprises a first background, and the method further comprises: receiving an input to change the background from a first background to a second background; and updating the first background to the second background.
Clause 8. The method of clause 1, wherein the at least one attribute includes a color or a brightness.
Clause 9. A computing system comprising: a computer-readable storage medium; at least one processor operatively coupled to the computer-readable storage medium; and program instructions stored on the computer-readable storage medium that, when executed by the at least one processor, direct the at least one processor to perform a method, the method comprising: in response to a request to display a virtual object on an extended reality device, determining at least one attribute associated with a physical environment behind a location for display of the virtual object in the extended reality device; determining a background for the virtual object based on the at least one attribute; and displaying the virtual object on a display with the background.
Clause 10. The computing system of clause 9, wherein the location comprises a first location, wherein the background comprises a first background, and the method further comprising: identifying a request to move the virtual object from the first location for display to a second location for display; determining at least one additional attribute associated with the physical environment behind the second location for display; determining a second background for the virtual object based on the at least one additional attribute; and displaying the virtual object on the display with the second background in place of the first background.
Clause 11. The computing system of clause 9, wherein the background comprises a first background, and the method further comprises: determining a change of the at least one attribute to at least one second attribute; determining a second background for the virtual object based on the change of the at least one attribute to at least one second attribute; and updating the virtual object on the display with the second background in place of the first background.
Clause 12. The computing system of clause 9, wherein the background modifies at least a portion of the physical environment visible as a passthrough to a user of the extended reality device.
Clause 13. The computing system of clause 9, wherein the background comprises a border around the virtual object.
Clause 14. The computing system of clause 9, wherein the method further comprises: determining at least one additional attribute associated with a color for the virtual object, wherein determining the background for the virtual object based on the at least one attribute is further based on the at least one additional attribute.
Clause 15. The computing system of clause 9, wherein the background comprises a first background, and the method further comprises: receiving an input to change the background from a first background to a second background; and updating the first background to the second background.
Clause 16. The computing system of clause 9, wherein the at least one attribute includes a color or a brightness.
Clause 17. A computer-readable storage medium having program instructions stored thereon that, when executed by at least one processor, direct the at least one processor to perform a method, the method comprising: in response to a request to display a virtual object on an extended reality device, determining at least one attribute associated with a physical environment behind a location for display of the virtual object in the extended reality device; determining a background for the virtual object based on the at least one attribute; and displaying the virtual object on a display with the background.
Clause 18. The computer-readable storage medium of clause 17, wherein the location comprises a first location, wherein the background comprises a first background, and the method further comprising: identifying a request to move the virtual object from the first location for display to a second location for display; determining at least one additional attribute associated with the physical environment behind the second location for display; determining a second background for the virtual object based on the at least one additional attribute; and displaying the virtual object on the display with the second background in place of the first background.
Clause 19. The computer-readable storage medium of clause 17, wherein the background comprises a first background, and the method further comprises: determining a change of the at least one attribute to at least one second attribute; determining a second background for the virtual object based on the change of the at least one attribute to at least one second attribute; and updating the virtual object on the display with the second background in place of the first background.
Clause 20. The computer-readable storage medium of clause 17, wherein the method further comprises: determining at least one additional attribute associated with a color for the virtual object, wherein determining the background for the virtual object based on the at least one attribute is further based on the at least one additional attribute.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
in response to a request to display a virtual object on an extended reality device, determining at least one attribute associated with a portion of a physical environment, wherein a location for display of the virtual object is between a user of the extended reality device and the portion of the physical environment;
determining a background for the virtual object based on the at least one attribute; and
displaying the virtual object on a display with the background.

2. The method of claim 1, wherein the location comprises a first location, wherein the background comprises a first background, and the method further comprising:
identifying a request to move the virtual object from the first location for display to a second location for display;
determining at least one additional attribute associated with a second portion of the physical environment behind the second location for display;
determining a second background for the virtual object based on the at least one additional attribute; and
displaying the virtual object on the display with the second background in place of the first background.

3. The method of claim 1, wherein the background comprises a first background, and the method further comprises:
determining a change of the at least one attribute to at least one second attribute;
determining a second background for the virtual object based on the change of the at least one attribute to at least one second attribute; and
updating the virtual object on the display with the second background in place of the first background.

4. The method of claim 1, wherein the background modifies at least a portion of the physical environment visible as a passthrough to a user of the extended reality device.

5. The method of claim 1, wherein the background comprises a border around the virtual object.

6. The method of claim 1 further comprising:
determining at least one additional attribute associated with a color for the virtual object,
wherein determining the background for the virtual object based on the at least one attribute is further based on the at least one additional attribute.

7. The method of claim 1, wherein the background comprises a first background, and the method further comprises:
receiving an input to change the background from a first background to a second background; and
updating the first background to the second background.

8. The method of claim 1, wherein the at least one attribute includes at least one of color or a brightness.

9. A computing system comprising:
a computer-readable storage medium;
at least one processor operatively coupled to the computer-readable storage medium; and
program instructions stored on the computer-readable storage medium that, when executed by the at least one processor, direct the at least one processor to perform a method, the method comprising:
in response to a request to display a virtual object on an extended reality device, determining at least one attribute associated with a portion of a physical environment, wherein a location for display of the virtual object is between a user of the extended reality device and the portion of the physical environment;
determining a background for the virtual object based on the at least one attribute; and
displaying the virtual object on a display with the background.

10. The computing system of claim 9, wherein the location comprises a first location, wherein the background comprises a first background, and the method further comprising:
identifying a request to move the virtual object from the first location for display to a second location for display;
determining at least one additional attribute associated with a second portion of the physical environment behind the second location for display;
determining a second background for the virtual object based on the at least one additional attribute; and
displaying the virtual object on the display with the second background in place of the first background.

11. The computing system of claim 9, wherein the background comprises a first background, and the method further comprises:
determining a change of the at least one attribute to at least one second attribute;
determining a second background for the virtual object based on the change of the at least one attribute to at least one second attribute; and
updating the virtual object on the display with the second background in place of the first background.

12. The computing system of claim 9, wherein the background modifies at least a portion of the physical environment visible as a passthrough to a user of the extended reality device.

13. The computing system of claim 9, wherein the background comprises a border around the virtual object.

14. The computing system of claim 9, wherein the method further comprises:
determining at least one additional attribute associated with a color for the virtual object,
wherein determining the background for the virtual object based on the at least one attribute is further based on the at least one additional attribute.

15. The computing system of claim 9, wherein the background comprises a first background, and the method further comprises:
receiving an input to change the background from a first background to a second background; and
updating the first background to the second background.

16. The computing system of claim 9, wherein the at least one attribute includes a color or a brightness.

17. A computer-readable storage medium having program instructions stored thereon that, when executed by at least one processor, direct the at least one processor to perform a method, the method comprising:
in response to a request to display a virtual object on an extended reality device, determining at least one attribute associated with a portion of a physical environment, wherein a location for display of the virtual object is between a user of the extended reality device and the portion of the physical environment;
determining a background for the virtual object based on the at least one attribute; and
displaying the virtual object on a display with the background.

18. The computer-readable storage medium of claim 17, wherein the location comprises a first location, wherein the background comprises a first background, and the method further comprising:
identifying a request to move the virtual object from the first location for display to a second location for display;
determining at least one additional attribute associated with a second portion of the physical environment behind the second location for display;
determining a second background for the virtual object based on the at least one additional attribute; and
displaying the virtual object on the display with the second background in place of the first background.

19. The computer-readable storage medium of claim 17, wherein the background comprises a first background, and the method further comprises:
determining a change of the at least one attribute to at least one second attribute;
determining a second background for the virtual object based on the change of the at least one attribute to at least one second attribute; and
updating the virtual object on the display with the second background in place of the first background.

20. The computer-readable storage medium of claim 17, wherein the method further comprises:
determining at least one additional attribute associated with a color for the virtual object,
wherein determining the background for the virtual object based on the at least one attribute is further based on the at least one additional attribute.
